(19) United States
(12) Patent Application Publication
(10) Pub. No.: US 2010/0069257 A1
(43) Pub. Date: Mar. 18, 2010

(54) POROUS SAMPLE TESTING DEVICE AND METHODS

(75) Inventors: J. Keith Harris, Midland, MI (US); Linda Ann Moore, Midland, MI (US); Jessica Lynn Bell, Saginaw, MI (US); Jeffrey D. Michalowski, Midland, MI (US); Kari Sue Phillipson, Hemlock, MI (US)

Correspondence Address: The Dow Chemical Company, Intellectual Property Section, P.O. Box 1967, Midland, MI, 48641-1967, US

(73) Assignee: DOW GLOBAL TECHNOLOGIES INC., Midland, MI (US)

(21) Appl. No.: 12/558,827

(22) Filed: Sep. 14, 2009

Related U.S. Application Data
(60) Provisional application No. 61/096,870, filed on Sep. 15, 2008.

(51) Int. Cl. C40B 40/00; C40B 40/14; C40B 30/00; C40B 30/04

(52) U.S. Cl. 506/9; 506/13; 506/20; 506/7

(57) ABSTRACT

Described are devices and methods for parallel testing of formulations on various substrates.

### CROSS REFERENCE TO RELATED APPLICATIONS

This Application claims the benefit of U.S. Provisional Application No. 61/096,870, filed on Sep. 15, 2008.

### FIELD

The present invention generally relates to parallel testing of formulations on various substrates.

### BACKGROUND

A number of research and testing procedures require the use of an array in which multiple formulations are screened or evaluated simultaneously. For example, formulations are evaluated for their impact on removing a coating, film, or soil deposited on porous substrates like cloth, paper, wood, non-woven plastic fibers, etc. This process is done by first contacting the soiled substrate with the test formulation, then allowing the combination to stand, with or without mechanical agitation, for a pre-defined period. During this process, the formulation must not leak or wick out of the test area, and particularly not into the adjacent test area. In the prior art, such “cross talk”, or cross contamination, or wicking, is addressed by using an o-ring under compression to produce a liquid-tight seal. However, formulation wicking is a common issue with porous substrates even under very high compression loads.

One of the possible methods of high throughput screening of different fabric care formulations and compositions is to place individual pieces of fabric (swatches) to be tested in an array of small vessels or sample vials. The sample arrays are evaluated by exposure to the test formulations under controlled conditions. However, a major drawback to this process is the manual handling of the individual test swatches throughout the testing procedure. If the pieces of fabric are to be removed from the vials or vessels, special handling equipment is needed. Labeling each of the individual fabric swatches is also important to prevent misidentification.

Another strategy to prevent formulation wicking involves coating the porous substrate with an impermeable sealant, which penetrates the porous material. The sealant is then cured, producing a barrier which isolates one test region of the porous material from another by preventing wicking between adjacent test regions, popularly known as “silk screening” technique. This is also labor intensive, and requires careful selection of the sealer for durability, compressibility, and chemical resistance to the test formulation. Another limitation for this technique is that the coating material does not penetrate every porous material equally because of differences in surface tension.

Thus there is a need for a device and method for testing the same or different compositions in parallel with a plurality of porous test regions, with the same or different porous substrates, having the same or different soils, which can be easily analyzed after completion of testing.

### SUMMARY

The present invention provides a test sample array ad methods for use in testing a plurality of compositions in parallel. In one embodiment, the present invention provides a test sample array, comprising a plurality of sheets laminated together, each of said sheets having aligned openings to form a passage extending axially through the laminated sheets, and a porous substrate disposed in the passage, wherein a portion of the porous substrate is entrained between two sheets. The above describes some of the advantages of the present invention and deficiencies of the prior art solved by the present invention. Other features, advantages, and embodiments of the invention will be apparent to those skilled in the art from the following description, drawings, and claims.

### BRIEF DESCRIPTION OF THE DRAWINGS

FIG. 1 is an exploded view of a test sample array according to one embodiment of the present invention.

FIG. 2 is a plan view of one sheet of the test sample array.

FIG. 3 is a plan view of the test sample array.

FIG. 4 is an exploded view of a test apparatus according to one embodiment of the present invention including the test sample array.

The drawings are understood to be for illustrative purposes only. As will be appreciated, elements shown in the embodiments herein can be added, exchanged and/or eliminated so as to provide any number of additional embodiments. In addition, the proportion and the relative scale of the elements provided in the figures are intended to illustrate some embodiments of the present invention, and should not be taken in a limiting sense.

### DETAILED DESCRIPTION

The present invention relates to a simple and convenient liquid testing device and methods for testing plurality of compositions in parallel. More specifically, the present invention solves the problems associated with cross-contamination or wicking of the samples for testing compositions in contact with porous substrates. The methods described can be used to test a plurality of compositions and/or mechanical properties associated with arrays of porous substrate samples in parallel. Furthermore, the testing can be accomplished with very small samples of porous substrate materials.

In one embodiment, the present invention provides a test sample array, comprising a plurality of sheets laminated together, each of said sheets having aligned openings to form a passage extending axially through the laminated sheets, and a porous substrate disposed in the passage, wherein a portion of the porous substrate is entrained between two sheets. In one embodiment, the test sample array is used for testing or optimization of fluids. Examples of fluids include cleaning compositions, dyes, wood sealers, coating compositions, masonry sealers, and the like. Alternatively, different concentrations of the same active in a fluid may be tested. The fluids may be gas, liquid, or foam, or they may be solid or granular compounds designed to dissolve upon contact with water.

In one embodiment, the present invention provides a test sample array, comprising, an upper sheet provided with a plurality of individual openings extending there through, a center sheet provided with a plurality of test regions aligned with the individual openings in said upper sheet, at least two of said test regions containing a porous substrate sample, and a lower sheet provided with a plurality of openings corresponding to the number of, and aligned with, the test regions in said center sheet, wherein the sheets are laminated together with the center sheet interposed between the lower sheet and the upper sheet.

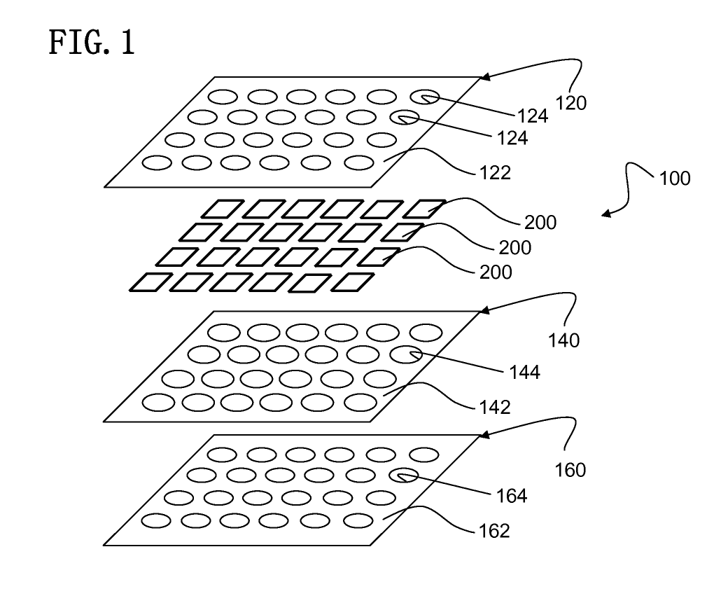

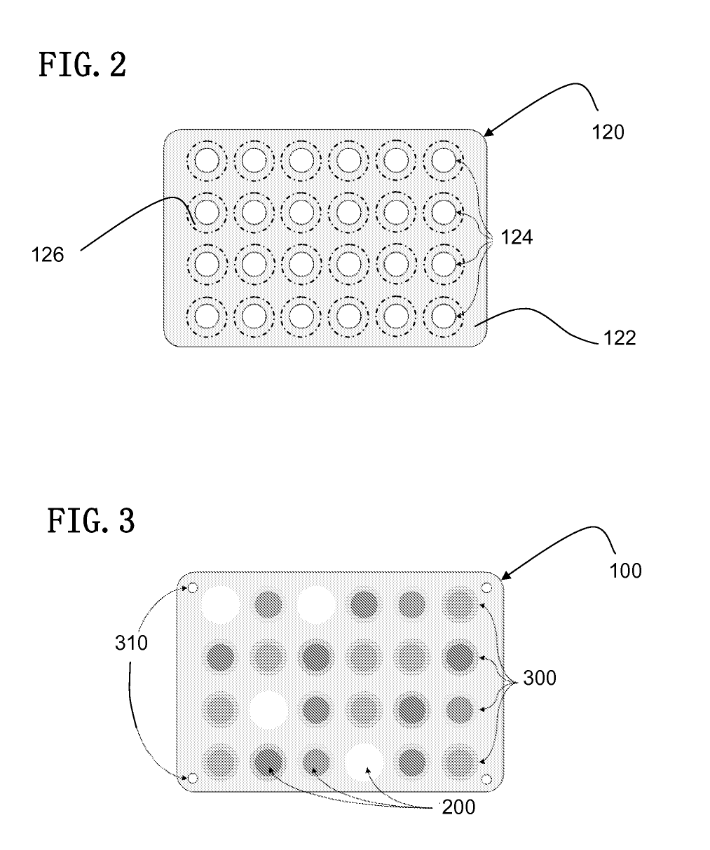

Referring to FIG. 1, an exploded view of a test array 100 according to one embodiment of the present array is illustrated. The array 100 has a first, for convenience, denoted “upper,” sheet 120. Referring to FIGS. 1 and 2, the upper sheet 120 may be fabricated from a film 122 comprising polyethylene, polypropylene, polystyrene, polyvinylchloride, polyesters, polyurethanes, epoxies, and polyacrylates and their mixtures thereof. Preferably, the film 122 is made of laminating materials.

Laminating materials broadly fall into two categories based on their method of adhesion either pressure-sensitive (using chemical adhesive) or thermo-compression or heat-activated. Pressure-sensitive, or cold products, rely on pressure to activate their adhesive layer. Under pressure, such products form a mechanical bond and or chemical bond with the substrate material. Generally pressure-sensitive laminating films or pouches are ideal for lower temperatures like 100° F. to 110° F. Pressure-sensitive films perform best on flat, rigid surfaces. Heat-activated or thermal laminates rely on heat and pressure to activate their adhesive layer.

Many of heat-activated laminating films offer relatively low temperature activation, so as not to disturb the chemical composition of the substrates while still providing a strong bond. These low temperature heat-activated laminates are sometimes referred to as heat set films to differentiate them from thermal films with higher activation temperatures of up to 235° F.

In one embodiment, a heat roller laminator is used to seal the laminating materials. Alternatively, instead of passing the array through the laminator, platens can be heated to between 250 and 350° F. then applied to either side of the test sample array for between 10 and 30 seconds, depending on temperature. The heat from the platens melts the laminate sheets and adheres the layers together. One advantage of this method is the that it allows the user to work with test sample arrays that that are thicker than the standard array and therefore can not be passed through the laminator. A second advantage is that platens can be fabricated that contain holes corresponding to the test areas to avoid the application of heat to the actual sample, thus reducing any unwanted effects that thermal exposure may generate.

It is understood that processes different than those described herein may be used to form the test sample array without departing from the scope of the invention. For example, the lamination is made using chemical means and pressed together with pressure and/or heat. In summary, the term “lamination” here in used, is defined as two or more sheets held together by a test formulation-insoluble adhesive which is activated either by thermal compression or by adhesive.

The thickness of the upper sheet generally runs from about 0.1 to about 0.2 mm, preferably about 0.127 mm. The upper sheet 120 has a plurality of individual openings 124 extending there through. The openings may be any shape, and formed in any conventional manner. Immediately adjacent to the openings 124 are zones 126 (FIG. 2) which corresponds to an opening of the sheet adjacent to it, as will be described. The zones 126 also represent an amount of material from the sheet that will be laminated onto the substrate.

Returning to FIG. 1, the array 100 has an interior, for convenience, denoted “center,” sheet 140. The center sheet 140 may be fabricated from a film 142 comprising polyethylene, polypropylene, polystyrene, polyvinylchloride, polyesters, polyurethanes, epoxies, and polyacrylates and their mixtures thereof. Preferably, the film 142 comprises the laminating materials described above, but it need not be. For example, the center sheet may be uncoated polypropylene, polystyrene, polyacrylate, or any other flexible material to which the laminate sheets form a tight seal.

The center sheet 140 has a plurality of individual openings 144 extending there through. In one embodiment, the openings 144 of the center sheet are relatively larger than the individual openings 124 and 164 of the upper and lower sheets respectively, in one embodiment, at least 1-3 mm larger. The openings may be any shape, and formed in any conventional manner. The center sheet may be thin (>1 mil) or thick (<1 mm), provided it is composed of a material that forms a strong bond with the laminate sheet(s). The thickness of the center sheet generally runs from about 0.1 to about 0.2 mm, preferably about 0.127 mm.

In a preferred embodiment, the center sheet 140 may be colored, patterned, or labeled to prove useful in either sample identification or processing. For example, the center sheet might bear alignment marks to allow orientation of the array during testing (i.e., front, back, up, down, right, left), or numbers associated with the openings to be coded with individual samples. In another embodiment, the colors, patterns, or labels may be present, but disposed elsewhere on the array.

The center sheet 140 receives the plurality of porous substrates 200. As used herein, the term “porous substrate” throughout this specification means a material with a porosity which allows the test formulation to penetrate beyond the substrate surface and which would, if in physical contact with adjacent test substrates, allow for the movement of the test formulation from one test substrate to an adjacent test substrate. The substrates may be composed of almost any porous and/or fibrous material and containing continuous micro or macro pores by which matter may be either absorbed or passed through. Particularly, where the pores allow passing-through of matter, the substrate is likely to be permeable. In one embodiment, the porous substrate samples are formed at least partially from woven fabric, non-woven fabric, paper, wood, non-woven plastic fibers, cementatious materials or combinations thereof. For example, cotton, polyester, rayon, blends, and the like, silica, alumina, cellulose, quartz, ceramic, sintered metals, plastics or any other porous material or combination of materials are contemplated. In one embodiment, the porous substrate 200 may be stained with oil or makeup or grease or blood, to test the effectiveness of laundry detergent compositions. Although depicted as squares, the porous substrates may be of any shape. Preferably, the porous substrates are circular. The size of the substrates 200 is mainly dictated by the size and density of the openings 144. It is important that each substrate 200 is not in fluid contact with another substrate or more than one opening 144.

The array 100 has a third, for convenience, denoted “lower,” sheet 160. The lower sheet 160 may be fabricated from a film 162 comprising polyethylene, polypropylene, polystyrene, polyvinylchloride, polyesters, polyurethanes, epoxies, and polyacrylates and their mixtures thereof. Preferably, the film 162 comprises the laminating materials described above. The lower sheet 160 has a plurality of individual openings 164 extending there through. The openings may be any shape, and formed in any conventional manner. The thickness of the lower sheet 160 generally runs from about 0.1 to about 0.2 mm, preferably about 0.127 mm. In one embodiment, the lower sheet 160 is substantially similar to the upper sheet 120.

To assemble, the substrates 200 are aligned adjacent to the center sheet 140. The upper sheet 120 and lower sheet 160 are stacked on either side of the center sheet 140 with their respective openings (124, 144, and 164) in axial alignment with one another. The sheets are laminated together, i.e., with the center sheet interposed between the lower sheet and the upper sheet and the substrates 200 are entrained in the lamination. The lamination of the sheets isolates each substrate and prevents fluid flow between substrates. The lamination is carried out either by thermal compression or with chemical adhesive. The thermal compression is carried out with in a temperature range of about 200° F. to 400° F., preferably in the range of 220-300° F. Further, the chemical adhesive used in the lamination of the test sample array is selected from adhesives such as urethanes, epoxies, isocyanates, and acrylates and combinations there of.

FIG. 3 shows the laminated test sample array 100 with entrained substrates 200. The aligned openings (124, 144, and 164) and substrate 200 form a fluid tight test region 300 for the substrate. Twenty-four (or multiples of four) test regions 300 are arranged to correspond to a standard microtiter plate format. However, the number of test regions is understood to be selected to correspond to the analytical method employed and is preferably at least 4, 8, 16, 24, 48, 56, 96, 128, 256, 384, 512, 1024, 2048, 4096 or more. The test regions 300 may all have substantially identical porous substrate samples 200 for testing different compositions of the test fluids. Alternatively, the test regions 300 may each have different porous substrates contained thereon or different compositions of test fluids may be used with different porous substrates.

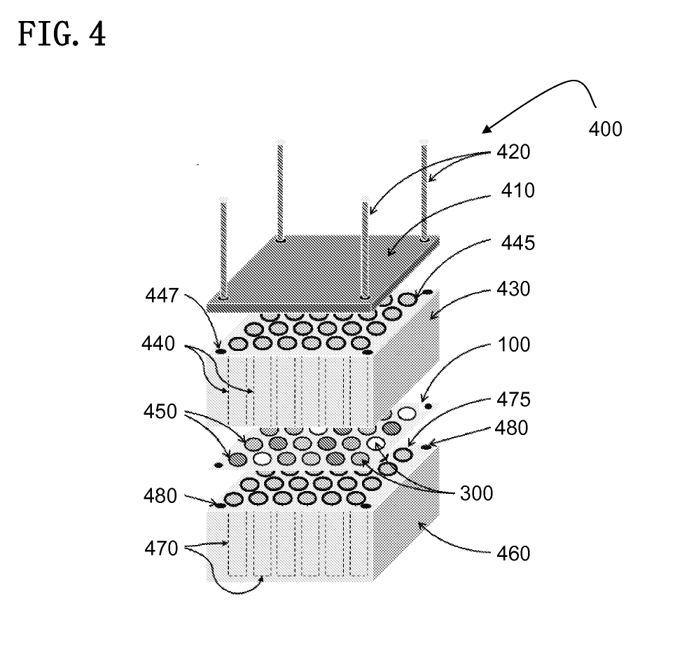

As shown in FIG. 4, an apparatus 400 used for testing a plurality of compositions in parallel includes the array 100 with substrates (not numbered) separated by the lamination seal into test regions 300. The apparatus has a cover plate 410 with attachment and alignment means 420 for reasons to be described. The attachment and alignment means 420 may be a bolt, rod, detent, or other conventional means. The cover plate 410 may optionally include a plurality of sealable openings (not shown) sized for receiving a pipette or similar tool for inserting test fluid into the apparatus.

The apparatus 400 includes a first, for convenience denoted “upper,” block 430 that forms a housing. The upper block 430 may be metal, plastic, wood, ceramic, or any suitable, non-reactive material. The upper block 430 has bores 440 that extend through the block and are aligned with the test regions 300. O-rings 445 are disposed between the bores 440 and cover plate 410. It is understood that the O-ring could be replaced with other suitable sealing means, such as gaskets. An alignment bore 447 extends through the upper block for receiving the alignment means 420.

O-rings 450 are disposed between the bores 440 and array 100. Alternatively, the upper sheet of the array may be thick and compressible enough to serve as a gasket.

The apparatus 400 includes a second, for convenience denoted “lower,” block 460 that forms a housing. The lower block 460 may be metal, plastic, wood, ceramic, or any suitable, non-reactive material. The lower block 460 has bores that do not extend through the block, thus forming wells 470. The wells 470 are aligned with the test regions 300. O-rings 475 are disposed between the wells 470 and array 100. Alternatively, the lower sheet of the array may be thick and compressible enough to serve as a gasket. An alignment bore 480 extends into the lower block for receiving the alignment means 420. In one embodiment, the bore 480 is threaded so that there are no protrusions that could complicate use with conventional microplate formats. In another embodiment, the bore 480 extends through the lower block and the alignment means 420 receives a nut.

In an alternative embodiment, not depicted, the apparatus can be used with two upper blocks and cover plates instead of the lower block.

In one embodiment, the upper liquid bores 440 and the wells 470 each have a liquid volume of between 0.1 milliliters and 30 milliliters, preferably between 1 and 20, most preferably between 5 and 15.

The test sample array 100 may be flexible or rigid. The test sample array 100 includes non-porous regions having a porous substrate material at or on the test regions 300.

The apparatus 400 is under sufficient compression to prevent fluid from transferring between adjacent test regions 300. wells 470

As previously described, the porous samples are preferably permeable to allow liquid to pass there through. In order to create agitation of the fluid, the apparatus 400 is typically placed in a linear reciprocating mechanical shaker. The device is oriented such that the fluid movement is parallel to the linear movement of the shaker.

The test apparatus 400 may be placed into a test station (not shown) which includes the mechanical shaker and provides temperature control.

The test fluid is preferably a liquid (e.g., solution, dispersion, and/or emulsion), but can also include gaseous test liquids, or foams. Typical parameters for fluids include overall concentration, chemical composition, viscosity, polymer molecular weight distribution, phase differences, acidity, etc.

In operation, and referring to FIG. 4, the test sample array 100 is first positioned over the lower block 460 (containing the test formulations) with the alignment of the wells 470. The upper block 430 is placed over the test sample array 100 in such a manner that each of the bores 440 are in alignment with the test regions 300 of the test sample array. The top cover sheet 410 is optionally placed on top of the upper block 430 and screws or bolts are then inserted into the alignment holes and tightened to sealing engagement with the upper and lower blocks. The apparatus may be optionally placed into an oven or heating block to heat or warm the liquid.

After completion of test, the apparatus 400 is removed from the test station (not shown) and the top cover sheet 410 (if in place) is removed. A sample of each test fluid is removed from the bores 440. The remaining test fluid is then removed by turning the apparatus upside down and allowing the fluid to drain. The apparatus 400 may then be left to sit assembled for a period of time to allow the test regions 300 to dry to prevent fluid from transferring between adjacent test regions. Then the apparatus is disassembled and the test sample array 100 is separated from the system and the test sample array is dried.

The array 100 need not be used exclusively with the apparatus 400, in accordance with another embodiment of the present invention, the test sample array 100 is placed into a large container of the test solution and agitated. Alternately the upper block 430 may be omitted and the top cover 410 may directly contact the test samples array 100. Alternately the upper block 430 may be retained, but the lower block 460 may be replaced with a second cover plate (not depicted). Alternately no top cover plate 410 is attached to the upper block 430. In this configuration the apparatus would be agitated in an orbital movement.

The porous test samples may be screened for visual or by spectral techniques for qualitative or quantitative analysis respectively. For example, the spectral techniques are used to derive color density values and colorimetric parameters. Similarly, the amount of dye that is removed from the porous substrate or fabric is determined during the test, by analyzing the test fluid removed from the liquid chambers.

In a preferred application, the present invention is used in a combinatorial, high-throughput research program directed to developing improved fabric-care compositions, or components thereof, improved porous substrate treatments, improved porous substrate compositions, or fabric-care process characterization and/or optimization. For instance, the fabric-care compositions include compositions comprising various laundry aids such as detergents, soaps, bleaches and softeners, among others. The test fluids can include components that are elements, compounds or compositions, and can typically include, polymers, surfactants, dyes, bleaches, perfumes, buffers, electrolytes, builders, sequestering agents, flame retardants, and/or enzymes alone or in various combinations thereof.

The high-throughput screening for libraries of fabric-care compositions can include an initial primary screening, in which various test fluids and/or porous substrates are quickly evaluated to provide valuable preliminary data and, optimally, to identify particular candidate materials having characteristics that meet or exceed certain predetermined metrics, for example, performance characteristics, desirable properties, unexpected and/or unusual properties, etc. Initial screening is used reiteratively to explore compositional space in better detail. The preparation and evaluation of more focused candidate libraries can continue as long as the high-throughput screen can meaningfully distinguish between neighboring library compositions or compounds. If one or more candidate materials is satisfactorily identified, additional composition libraries are focused around the candidates and evaluated.

A variety of methods are generally known to those skilled in the art; many of these methods may be combined with the apparatus of the present invention to produce a test for adsorption which is parallel in nature and is used to test many substances at once. For instance, the apparatus may also be used as a parallel reactor for evaluating catalysts, and especially for evaluating heterogeneous catalyst candidates. In such applications, plurality of heterogeneous catalysts (or catalyst precursors) having different compositions are incorporated into the apparatus such that the plurality of catalyst candidates are simultaneously contacted with a reactant-containing fluid. The catalyst materials can be bulk, or supported catalyst materials. The catalyst materials are preferably incorporated into the test apparatus as part of the porous substrate. For example, the catalyst candidates (or catalyst precursors) can be impregnated into the porous substrate sample of test regions, calcined, and then integrated into the parallel reactor. In any format, each of the plurality of candidate catalysts are preferably provided in discrete test regions to avoid cross-talk between catalysts.

Conversely the invention may be used to extract substances from porous materials. The samples can be incorporated into the test apparatus as part of the porous substrate with the material of interest in the test region. The device is then filled with a liquid known to extract the substance of interest from the porous substrate and the samples are processed at the desired temperature for the desired duration. Upon completion of processing, the porous substrate is removed and the liquid is collected for analysis.

The following examples are provided by way of illustration only and should not be construed to limit the scope of the invention.

### EXAMPLES

The following examples are for illustrative purposes only and are not intended to limit the scope of the present invention.

### Example 1

A 3½ inch by 5½ inch medium weight 5 mil GBC® HeatSeal™ thermal laminating pouch is used to simulate upper and lower sheets. A 24-well (4×6) array is traced onto the top of the laminate using a Teflon block as a template. The traced pattern is used to punch twenty-four 5/16 inch openings. A corresponding 24-well (4×6) array center template is punched from a piece of C-Line Products, Inc. Heavyweight Clear Polypropylene Sheet Protector using a 7/16 inch punch. Twenty-four fabric circles or porous substrate samples are cut from a piece of Quilter's Solid fabric using a 7/16 inch punch.

The punched center sheet (polypropylene sheet) is placed in between the two sheets (upper and lower) and the openings of the upper and lower sheets of laminating pouch are aligned in the center of the larger center sheet test region openings. The fabric circles are placed in the test region openings of the center sheet template. The fabric circles and center sheet template are centered as closely as possible with the upper sheet openings, and the entire laminate composite is placed in a carrier and fed through a thermal laminator at 300° F. (for example, Jackson-Hirsh, Inc. Card/Guard Model 7200). Each piece of fabric is substantially isolated from the adjacent swatches by the laminate sheet. The fabric is securely held in the laminated test sample array because the upper and lower sheets adhere to the fabric sample along the perimeter of the sample. As will be appreciated, fluid can pass through the sample because of the punched openings.

### Example 2

Using an array such as described in Example 1, samples can be tested. Substrates are Blank fabric—unstained, 100% cotton, sold as “Quilters Only Solid” fabric, and the following different types of stained fabric from Scientific Services (Sparrow Bush, N.Y.) and the lot numbers associated with them:
1. Coffee—Lot #9752
2. Dust Sebum—Lot #9828 , Lot #9997
3. Grape Juice—Lot #108
4. Grass—Lot #9722
5. Make-up—Lot #9753

Such arrays are useful in laundry detergent efficacy tests.

### Example 3

Using an array such as described in Example 1, samples can also be prepared from thin layers of cellulosic materials like paper or wood. In general, the test of wood evaluates the effectiveness of an applied coating or stain to resist penetration by a given solution. An aqueous test solution containing a red dye is prepared. The coated wooden substrates are cut into ½″ circles in the same manner as the other porous substrates. The test array is assembled in the same manner as the test array integrating cloth samples except that in this case the center sheet of the composite is much thicker; typically ⅛″, the same thickness as the wood samples.

The samples are positioned in the same manner as with the cloth, the test array is laminated and the composite is digitally imaged. The test array is then loaded in the test block, closed and placed on a shaker for 10 minutes. Upon completion of shaking the block is disassembled, the test array is removed and wiped dry. The test array is the digitally imaged as it was prior to testing. Comparison of the digital images looks for areas where the red dye is visible. Variations in application thickness and dry-time allow determination of optimal coating conditions.

### Example 4

Using the lamination method described above in Example 1, thin sheets of wood or wood veneer can replace the fabric swatches to prepare a test sample array. For example, wood veneer edging (such Band-it Real Wood Edging, Iron On, Red Oak from Lowe's). The laminate center sheet is slightly thicker with the wooden substrates than with the fabric to accommodate the increased thickness of the wooden samples. The wooden samples are coated with a wood sealer prior to the lamination process. The samples are exposed to an aqueous-borne dye that reacts with the wood. Aggregates, chemical additives or detergents may or may not be added to the test solution. Test conditions such as shake speed, shake duration and temperature are adjusted to simulate the desired “real world” conditions. The apparatus is placed into the shaker for the specified time. After completion of the test, the test sample array is removed, blotted dry and allowed to stand for a minimum of 1 hour. The porous test samples may be screened by visual or spectral techniques for qualitative or quantitative analysis respectively. The presence of dye indicates a defect in the sealant.

### Example 5

Using the lamination method described above in Example 1, an array of single type of stained fabric swatches is prepared. The soil may be selected from Coffee, Dust Sebum, or Grape Juice. The samples are exposed to different detergent formulations. The upper block is placed over the test sample array in such a manner that each of the upper liquid chambers are in alignment with the test regions of the test sample array. The testing liquids are placed in the upper and lower blocks. The apparatus is placed into a shaker bath at the desired temperature for an effective testing.

After completion of test, the test apparatus is dissembled from the test station. A sample of each test fluid is removed from the upper liquid chambers. The remaining test fluid is then removed by turning the apparatus upside down and allowing the fluid to drain from the upper liquid chambers. The test apparatus may then be left to sit assembled for a period of time to allow the test regions to drain to prevent fluid from transferring between adjacent test regions. Then the apparatus is disassembled and the test sample array is separated from the system and dried. The porous test samples may be screened by visual or spectral techniques for qualitative or quantitative analysis respectively.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and sub combinations of ranges, as well as specific numerals contained therein. Additionally, the disclosures of each patent, patent application, and publication cited or described in this document are hereby incorporated herein by reference, in their entireties.

What is claimed is:

1. A test sample array, comprising,
a plurality of sheets laminated together, each of said sheets having aligned openings to form a passage extending axially through the laminated sheets, and
a porous substrate disposed in the passage, wherein a portion of the porous substrate is entrained between two sheets.

2. The test sample array of claim 1, wherein the porous substrate sample is selected from fabric, woven or non-woven, paper, wood, non-woven plastic fibers, cementatious materials and combinations thereof.

3. The test sample array of claim 1, comprising:
a first laminable sheet provided with a plurality of individual openings extending there through;
a second laminable sheet provided with a plurality of individual openings extending there through;
a third laminable sheet interposed between the first and second sheets, said third sheet provided with a plurality of test regions aligned with the individual openings in the first and second sheets, at least two of said test regions each containing a porous substrate sample.

4. The test sample array of claim 3, wherein the plurality of the test regions are sealed from each other.

5. The test sample array of claim 3, wherein said sheets are laminated together by thermal compression or with adhesive.

6. The test sample array of claim 5, wherein the adhesive is an adhesive comprising acrylates, epoxies, and urethanes, or combinations thereof.

7. The test sample array of claim 3, wherein said sheets are laminated together by thermal compression at a temperature range of about 200° F. to 400° F., preferably in the range of 220-300° F.

8. The test array as claimed in claim 3, wherein said upper, lower and central sheets are prepared from materials selected from polyethylene, polypropylene, polystyrene, polyvinylchloride, polyesters, polyurethanes, epoxies and polyacrylates and their mixtures thereof.

9. The test sample array of any of the previous claims wherein the porous substrate is the same in each of the test regions.

10. The test sample array of any of the previous claims wherein the porous substrate is different in at least some of the test regions.

11. A method of analyzing test fluids comprising,
a. providing the test sample array of claim 1;
b. contacting each of the plurality of test regions with at least one test fluid for performing a plurality of tests in parallel; and
c. thereafter, analyzing the test regions.

12. The method of claim 11 wherein the plurality of test regions contain different porous substrates.

13. The method of claim 11, wherein the plurality of test regions contain identical porous substrates.

14. The method of claim 11, wherein the test fluid is a fabric-care composition, a wood sealer or coating composition, or a masonry sealer or coating composition.

15. The method of claim 11, wherein the different test fluids vary with respect to one or more properties selected from the group consisting of chemical composition, concentration, hydrophilicity, molecular weight, molecular weight distribution, viscosity, acidity, dipolar characteristics, charge, and hydrogen-bonding characteristics.
